(19) United States
(12) Patent Application Publication
(10) Pub. No.: US 2025/0272678 A1
(43) Pub. Date: Aug. 28, 2025

(54) PROOF-OF-TRUST BASED MULTIDIMENSIONAL CRYPTO-PLATFORM PAYMENT GATEWAY

(71) Applicant: Bank of America Corporation, Charlotte, NC (US)

(72) Inventors: Gowri Sundar Suriyanarayanan, Chennai Tamil Nadu (IN); Maneesh Sethia, Hyderabad Telangana (IN); Keerthana Subramani, Chennai Tamil Nadu (IN)

(21) Appl. No.: 18/586,848

(22) Filed: Feb. 26, 2024

(51) Int. Cl. G06Q 20/38; G06Q 20/06; G06Q 20/40; H04L 9/00

(52) U.S. Cl. CPC G06Q 20/389; G06Q 20/065; G06Q 20/4014; H04L 9/008; G06Q 2220/00

(57) ABSTRACT

Methods, apparatus, and systems for resource efficient and decentralized approval and persistence of pending crypto transactions are provided. Methods may include receiving, at a unified payment gateway, a transaction data packet from a crypto payment platform. The unified payment gateway may be included in a multidimensional crypto payment (“MCP”) network. The method may include transmitting the transaction data packet to a knowledge graph. The methods may include selecting a final-approver node from a group of nodes included in the MCP selected using the knowledge graph. The final-approver node may be a node having a highest assigned approval score. The methods may include validating the final-approver node. In response to validating the smart contract, the methods may include approving the pending crypto transaction and storing the crypto transaction in the MCP network.

### FIELD OF TECHNOLOGY

Aspects of the disclosure relate to authentication, approval and storage of crypto transactions.

### BACKGROUND OF THE DISCLOSURE

Cryptocurrency is a digital payment system that relies on peer-to-peer verification. Crypto transactions are stored as digital entries in a distributed public ledger. The distributed public ledger may be a blockchain. Cryptocurrency utilizes the blockchain to process the crypto transactions. A blockchain is a distributed database of records or public ledger of all transactions or digital events that have been executed and shared among participants. Each transaction or digital event in the public ledger is verified by a majority of participants included in the system. Once a transaction or digital event is executed, it can never be erased. Therefore, the blockchain contains a certain and verifiable record of every single transaction.

Because of the unique characteristics specific to blockchain technology—i.e., no central database and the inability to erase a transaction—blockchain technology has the ability to revolutionize the digital world by enabling a distributed record of every online transaction that can be verified at any time in the future. Blockchain technology does not compromise the privacy of digital assets and the parties involved because the blocks, included on the chain, either do not include private data or include an encrypted version of private data. The distributed consensus and the anonymity are two important characteristics of blockchain technology.

Prior to adding the crypto transaction to the blockchain, the crypto transaction is validated by other users of the blockchain, called validators. The validator of the blockchain may be a member of a network associated with the blockchain. The validator of the blockchain may validate the new block using a proof-of work-validation process and/or a proof-of-stake validation process. A proof-of-work validation process may involve competition of various members to determine an unidentified numerical value. A proof-of-stake validation process may involve a single assigned member determining the unidentified numerical value. The new block may be closed upon confirmation, by the blockchain network, of the unidentified numerical value.

Proof-of-work verification is a process that involves competition of various members to determine an unidentified numerical value. Proof-of-work verification is a software algorithm used by cryptocurrency blockchains to ensure blocks are regarded as valid if they require a certain amount of computation power to produce. Data miners, users of the blockchain, compete to see which data miner can solve the most complex hashes in order to earn the right to process each block. Proof-of-work verification methods, therefore, tend to be extensively resource consumptive due to the competition over finding the unidentified numerical value. Additionally, the resource consumptive nature of proof-of work verification generally incurs a plurality of different expenses causing proof-of-work verification to have a large overhead cost.

Proof-of-stake verification, on the other hand, is a consensus in which a user of the blockchain validates incoming crypto transactions and add them as new blocks on the blockchain. Users of the blockchain put in a stake of cryptocurrency to be considered a validator. Increasing the stake of cryptocurrency increases the chance of being selected as a validator. Proof-of-stake verification uses less computing power and has a lower overhead cost than proof-of-work verification. However, proof-of-stake verification typically has a higher potential for centralization, as users with a greater stake usually have more influence in determining which users can complete transaction verifications. Centralization can lead to dominance of transaction verifications by a few users. Dominance of transaction verifications by a few users introduces a greater vulnerability of security breaches.

Therefore, it would be desirable to provide a system for a decentralized, resource efficient, and secure crypto payment verification.

### SUMMARY OF THE DISCLOSURE

Systems, apparatus and methods for resource efficient and decentralized verification, approval, and storage of pending crypto transactions are provided. The method may leverage smart contracts, non-fungible tokens and knowledge graphs.

The methods may include receiving, at a unified payment gateway, a transaction data packet. The unified payment gateway may be a payment gateway that is configured to receive, process and approve pending transactions. The unified payment gateway may receive a transaction data packet from one or more crypto payment platforms. Crypto payment platforms may include payment platforms that are configured to manage and execute crypto transactions. Examples of crypto payment platforms include, bitcoin platforms, crypto automated teller machines (“ATMs”), crypto lending platforms, multidimensional metaverses and any other suitable crypto payment platform.

The unified payment gateway may be included as part of a multidimensional crypto payment (“MCP”) network. The MCP network may be a decentralized network. The MCP network may be a distributed network. The MCP network may be a blockchain. The MCP may include one or more nodes. The one or more nodes may be computing devices, peripheral devices and/or any other suitable network devices. The computing devices may include desktop computers, laptops, tablets, smartphones, personal device assistants (“PDAs”), mainframe computers and/or any other suitable computing devices.

The transaction data packet may include data relating to a pending crypto

transaction. The pending crypto transaction may be executed between a sender node and a receiver node. The sender node may be a node associated with a sender of the transaction. The receiver node may be a node associated with a receiver of the transaction. The sender node may be included in the MCP network. The sender node may not be included in the MCP network. The receiver node may be included in the MCP network. The receiver node may not be included in the MCP network.

The transaction data packet may include data relating to sender node identification. Data relating to sender node identification may include an alphanumeric identification (“ID”) number, an internet protocol (“IP”) address and/or any other data that may be used to identify the sender node. The identification may be used to differentiate the sender node from other nodes. The transaction data packet may include data relating to receiver node identification. Data relating to receiver node identification may include an alphanumeric ID number, an IP address and/or any other data that may be used to identify the receiver node from. The identification may be used to differentiate the receiver node from other nodes.

The transaction data packet may include data relating to the pending crypto transaction. Data relating to the pending crypto transaction may include personal/confidential information related to the sender node or the receiver node. Personal/confidential information may include information such as sender node or receiver node financial information, sender node or receiver node authentication information and/or any other suitable non-public sender node or receiver node information. Data relating to the pending crypto transaction may include a location at which the transaction was initiated, a time at which the transaction was initiated, an amount of resources that was determined to be transferred through the transaction, and/or any other suitable data relating to the transaction.

In some embodiments, prior to receiving the transaction data packet at the unified payment gateway, methods may include homomorphically encrypting the transaction data packet. Homomorphic encryption may include conversion of data included in the transaction data packet into ciphertext that may be analyzed and worked with as if the data were in its original form. Homomorphic encryption may allow for data to be processed, analyzed and transmitted without having to decrypt the data. The homomorphic encryption may be a partial homomorphic encryption. A partial homomorphic encryption may include a homomorphic encryption consisting of only one type of mathematical gate, addition or multiplication gates. The homomorphic encryption may be a somewhat homomorphic encryption. A somewhat homomorphic encryption may include a homomorphic encryption including a finite number of addition and multiplication gates rather than an infinite number of one particular gate. The homomorphic encryption may be a full homomorphic encryption. A full homomorphic encryption may include a homomorphic encryption consisting of both addition and multiplication gates.

The methods may include homomorphically encrypting data relating to the pending crypto transaction and not homomorphically encrypting data relating to the sender node identification and the receiver node identification.

Data relating to the pending crypto transaction may be homomorphically encrypted to protect and secure any included personal/confidential information related to the sender or the receiver of the transaction. Data relating to sender node identification and receiver node identification may not be homomorphically encrypted. This may be because data relating to sender node identification and receiver node identification may not be personal/confidential information and, therefore, may not require homomorphic encryption. Furthermore, data relating to sender node identification and receiver node identification may be needed for approval and storage of the pending crypto transaction in the MCP network.

The methods may include transmitting the transaction data packet. The transaction data packet may be transmitted from the unified payment gateway. The transaction data packet may be transmitted to a knowledge graph.

The knowledge graph may represent a network of data. The knowledge graph may store the network of data. The knowledge graph may show connections within the stored network of data. The knowledge graph may include identification data of the one or more nodes included in the MCP network. Identification data may include an alphanumeric ID number, an IP address and any other data that can be used to identify a node. The identification may be used to differentiate one node from other nodes in the MCP network. The knowledge graph may include transaction data relating to previous transactions between one or more nodes. Transaction data may include data relating to whether previous transactions were successful. Transaction data may include any suitable data relating to previous transactions.

The methods may include identifying a group of nodes using the knowledge graph. Each node included in the group of nodes may have previously completed at least one transaction with the sender node. Each node included in the group of nodes may have previously completed at least one transaction with the receiver node. Each node included in the group of nodes may have previously completed at least one transaction with the sender node and at least one transaction with the receiver node.

The methods may include assigning an approver score to each node included in the group of nodes. The methods may include determining, for each node, a previous transaction history with the receiver node. The methods may include determining, for each node, a previous transaction history with the sender node. Previous transaction history may include data. Data may include whether the transaction was successfully completed, a length of time in which the transaction was completed, a computing resources consumption metric of resources consumed during the completion of the transaction, a security level of the transaction and any other suitable transaction history related information. Assigning an approver score may include determining a level of trustworthiness for each node based on the previous transaction history. The level of trustworthiness may be a level assigned to each node based on previous transaction histories with any previously attempted transactions.

The approver score may be assigned based on the determined previous transaction history with the receiver node, the determined previous transaction history with the sender node, and the determined trustworthiness level. The approver score may be a numerical value reflecting the likelihood of being selected as a final-approver node. The higher the approver score, the more likely it may be that the corresponding node may be selected as the final-approver node. A high approver score may reflect that previous transactions were completed in a short amount of time, consumed less than a threshold number of computing resources during the completion of the transaction, and enabled secure transactions. A high approver score may reflect a high trustworthiness level.

The methods may include selecting a final-approver node from the group of nodes. The final-approver node may be selected based on being assigned a highest assigned approval score. The methods may include comparing the assigned approval scores. The methods may include selecting the node that corresponds to the highest approval score.

The methods may include using the final-approver node to generate a non-fungible token (“NFT”) for approving the pending crypto transaction. An NFT may be unique digital identifier that may be used to certify ownership and authenticity of the node that created it. The generated NFT may be used for validating the final-approver node.

In parallel with the generating of the NFT, the methods may include transmitting final-approver node identification to a node consensus validator. Final-approver node identification may include an alphanumeric ID number, an IP address and any other data that can be used to identify the final-approver node. The identification may be used to differentiate the final-approver node from other nodes. The node consensus validator may be any node included in the MCP network. The node consensus validator may be a node configured to validate the final-approver node. The node consensus validator may be selected based on a determination of which node has a greatest amount of computing power bandwidth. The node consensus validator may be selected based on a determination of which node is in the closest proximity to the final-approver node. The node consensus validator may be selected based on any other suitable metric.

Validating the final-approver node may include creating a smart contract. A smart contract may include a computer code that has the power to execute and enforce itself, based on a series of programmed parameters. The smart contract may be created using the node consensus validator. The smart contract may include the sender node identification. The smart contract may include the receiver node identification. The smart contract may include the final-approver node identification. The smart contract may include the NFT. The smart contract may include a set of rules to use in order to validate the smart contract.

The set of rules may include a set of parameters that need to be met to enable the transaction between the sender node and receiver node. The set of rules may be a set of predetermined conditions that may enable the smart contract to execute and enforce itself when the conditions are met. Validating the smart contract may include solving the set of rules. Solving the set of rules may include meeting all the specified parameters. Solving the set of rules may enable the smart contract to execute and enforce itself. Enabling the smart contract to execute and enforce itself may trigger the pending crypto transaction to be approved and added to the MCP network. The smart contract may serve as a record of the approved crypto transaction and the nodes that were involved in approving the crypto transaction.

In response to validating the smart contract the methods may include approving the pending crypto transaction. After approving the crypto transaction, the methods may include storing the crypto transaction in the MCP network as an approved transaction. Storing the crypto transaction may include creating a block. The block may include the pending transaction. Storing the crypto transaction may include adding the block to the MCP network. In response to approving and storing the transaction, resources may be exchanged between the receiver node and sender node as specified by the transaction.

In some embodiments, methods may include tracking the final-approver node. The final-approver node may be tracked using a node vulnerability tracker. The node vulnerability tracker may be a node included in the MCP network configured to track other nodes. Tracking nodes may include monitoring performance metrics, computing bandwidth levels, trustworthiness levels, IP addresses and/or any other suitable metric of a selected node. Tracking the final-node approver may include monitoring any changes to an IP address assigned to/associated with the final-approver node. Tracking the final-approver node may include monitoring any changes of an assigned level of trust between the final-approver node and other nodes included in the MCP network. Tracking the final-approver node may include monitoring any changes in computing bandwidth levels associated with the final-approver node. Tracking the final-approver node may include monitoring any change in computing metrics of the final-approver node.

Based on the monitoring, the methods may include determining whether the IP address of the final-approver node has changed, whether the level of trust between the final-approver node and other nodes has diminished, whether the computing bandwidth levels have diminished and/or any other suitable computing metric has changed. In response to determining that a change in the IP address of the final-approver node, a diminishing of the level of trust between the final-approver node and other nodes, a diminishing in the computing bandwidth levels, and/or any changes in other suitable computing metric, the methods may include transmitting a command to the knowledge graph to select a new final-approver node from the group of nodes. The new final-approver node may be a node that is different from the previously selected final approver node.

In some embodiments, the methods may include dynamically updating the knowledge graph. The methods may include dynamically updating the knowledge graph in response to a node being added to the MCP network. The updating may include updating the knowledge graph with identification data of the node being added. Identification data of the node being added may include an alphanumeric ID number, an IP address and any other data that may be used to identify the sender node from other nodes. The updating may include updating the knowledge graph with transaction data relating to previous and ongoing transactions between the node being added and one or more nodes included in the MCP network. The knowledge graph may be updated in real-time.

In other embodiments, the MCP network may be a first network. The nodes included in the MCP network may be first network nodes. The knowledge graph may be included in the first network. The knowledge graph may include identification data of the first network nodes. The knowledge graph may also include identification data of second network nodes. The second network nodes may be included in a second network. The second network may be a network that is different from the first network. The second network may be an edge network, distributed network, decentralized network, a local area network (“LAN”), a wide area network (“WAN”) and/or any other suitable network. The knowledge graph may include transaction data relating to previous and ongoing transactions between the first network nodes and the second network nodes.

The methods may include identifying, in the knowledge graph, a group of nodes from the first network nodes and the second network nodes. Each node included in the group of nodes may have previously completed at least one transaction with the sender node and at least one transaction with the receiver node. The methods may include selecting a final-approver node from either the first network nodes or the second network nodes. The final-approver node may be selected from the first network nodes. The final-approver may be selected from the second network nodes. The methods may further include validating the smart contract using a node selected from either the first network nodes or the second network nodes. The node selected for validating the smart contract may be selected from the first network nodes. The node selected for validating the smart contract may be selected from the second network nodes. In response to approving the crypto transaction, the methods may include storing the crypto transaction in the first network.

The methods may include updating the knowledge graph in response to a node being added to either the first network or the second network. The updating may include updating the knowledge graph with identification data of the node being added. The updating may include updating the knowledge graph with transaction data relating to previous and ongoing transactions between the node being added and other nodes from the first and second network nodes.

In some embodiments, the methods may include receiving, processing, verifying, approving and storing any suitable pending transaction from any suitable payment platform. Suitable pending transactions may include transactions using debit cards, credit cards, bank transfers, wire payments, digital wallets, checks, mobile payments, virtual credit cards and/or any other suitable payment mediums. Payment platforms may include Stripe™, PayPal™, Amazon Pay™, Square™, Adyen™, Apple Pay™ and/or any other suitable payment platforms.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure; and

FIGS. 4A-4B show yet another illustrative diagram in accordance with principles of the disclosure.

### DETAILED DESCRIPTION OF THE DISCLOSURE

Systems, apparatus and methods for resource efficient and decentralized verification, approval and storage of pending crypto transactions are provided. The unified payment gateway may leverage smart contracts, non-fungible tokens and knowledge graphs.

The unified payment gateway may be a node, a system, and/or a software application. The unified payment gateway may be included in a multidimensional crypto payment (“MCP”) network. The MCP network may include one or more nodes. The MCP network may be a decentralized network. The MCP network may be a blockchain. The MCP network may be a distributed network. The MCP network may be any suitable network. A node may include a computing device, a peripheral device, and/or any other suitable network related devices.

The unified payment gateway may include a receiver. The receiver may receive a transaction data packet from a crypto payment platform. Crypto payment platforms may include, but are not limited to, bitcoin platforms, crypto automated teller machines (“ATMs”), crypto lending platforms, and multidimensional metaverses.

The transaction data packet may include a pending crypto transaction between a sender node and a receiver node. The sender node and receiver node may be included in the MCP network. The pending crypto transaction may include a plurality of details relating the pending transaction, such as, a location of the transaction, an amount of resources being transferred, a time that the transaction was executed and/or any other suitable details relating to the pending transaction. The transaction data packet may include sender node identification. The transaction data packet may include receiver node identification. Node identification may include an alphanumeric identification (“ID”) number, an internet protocol (“IP”) address and any other data that can be used to identify a node. The data used to identify the node may be used to differentiate the node from other nodes in the MCP network.

Prior to transmitting the transaction data packet, the transaction data packet may be homomorphically encrypted. Homomorphic encryption may include conversion of data included in the transaction data packet into ciphertext that may be analyzed and worked with as if the data were in its original form. Homomorphic encryption may enable data to be processed, analyzed and transmitted without having to decrypt the data. Data relating to the pending crypto transaction may be homomorphically encrypted. Data relating to sender node identification and receiver node identification may not be homomorphically encrypted.

The unified payment gateway may include a transmitter. The transmitter may transmit the transaction data packet from the unified payment gateway to a knowledge graph. The knowledge graph may represent a network of data. The knowledge graph may store the network of data. The knowledge graph may show connections within the stored network of data. The knowledge graph may include hardware. The knowledge graph may include firmware. The knowledge graph may include any suitable combination of hardware and firmware.

The knowledge graph may include identification data of the one or more nodes. The knowledge graph may include transaction data relating to previous transactions between the one or more nodes. Transaction data may include data relating to a success rate of previous transactions, a length of time in which previous transactions were completed, a consumption metric of resources consumed during completion of the previous transactions and/or any other suitable previous transaction related data.

The knowledge graph may be dynamically updated. In response to a node being added to the MCP network, the unified payment gateway may update the knowledge graph with identification data of the node being added and transaction data relating to previous and ongoing transactions between the node being added and the one or more nodes included in the MCP network. The knowledge graph may be updated in real-time.

The unified payment gateway may include an approver segregator. The approver segregator may be included in the MCP network. The approver segregator may be configured to identify a final-approver node from the nodes included in the MCP network. The final-approver node may be a node that has previously completed at least one transaction with the sender node and at least one transaction with the receiver node. The approver segregator may identify, using the knowledge graph, a group of nodes. Each node included in the group of nodes may have previously completed at least one transaction with the sender node and at least one transaction with the receiver node.

The approver segregator may assign an approver score to each node included in the group of nodes. The approver score may be a numerical score. The approver score may be a numerical score, representing a likelihood of being selected as the final-approver node. The approver score may be assigned based on an identified previous transaction history with the receiver node. The approver score may be assigned based on an identified previous transaction history with the sender node. The approver score may be assigned based on an identified trustworthiness level. The trustworthiness level may be determined by analyzing previous transaction histories for each node. The approver score may be assigned based on any other suitable metric.

For example, approver scores may be percentages assigned to each node. A node, from the group of nodes, that is identified as having successfully completed multiple transactions with the sender node and/or the receiver node, may receive a high approver score, such as 90%. A node, from the group of nodes, that is identified as having failed to complete multiple transactions with the sender node and/or the receiver node, may receive a low approver score, such as 36%.

Based on the approver scores assigned, the approver segregator may select the node with the highest approval score. For example, five nodes may be identified as having successfully completed transactions with both the sender node and the receiver node. The approval scores assigned to the five nodes may be 17%, 38%, 64%, 77% and 66%, respectively. Based on the approval scores assigned, 77% may be determined to be the highest approval score. The approver segregator may select the node corresponding to the approval score of 77% as the final-approver node.

The unified payment gateway may include a non-fungible token (“NFT”) generator. The NFT generator may use the final-approver node to generate an NFT. The NFT may be used for approval of the pending crypto transaction.

The unified payment gateway may include a node consensus validator. The node consensus validator may be a node included in the MCP network that is configured to validate the final approver node. The node consensus validator may create a smart contract.

A smart contract may include a computer code that has the power to execute and enforce itself, based on a series of programmed parameters. The smart contract may include the sender node identification. The smart contract may include the receiver node identification. The smart contract may include final-approver node identification. The smart contract may include the NFT. The smart contract may include a set of rules to use in order to validate the smart contract.

The set of rules may be a set of parameters that need to be met to enable the transaction between the sender node and receiver node. The set of rules may be a set of predetermined conditions that may enable the smart contract to execute and enforce itself when the conditions are met. Validating the smart contract may include solving the set of rules. Solving the set of rules may include meeting all the specified parameters. Solving the set of rules may enable the smart contract to execute and enforce itself. Enabling the smart contract to execute and enforce itself may trigger the pending crypto transaction to be approved and added to the MCP network. The smart contract may be a record of the approved crypto transaction and the nodes that were involved in approving the crypto transaction.

The node consensus validator may validate the smart contract. The validation may include solving the set of rules. In response to validating the smart contract the unified payment gateway may approve the pending crypto transaction. Approving the transaction may include transmitting a message to both the sender node and the receiver node indicating approval of the transaction. After approval of the transaction, the unified payment gateway may store the crypto transaction in the MCP network. The unified payment gateway may store the transaction as a block in the MCP network.

The unified payment gateway may include a node vulnerability tracker. The node vulnerability tracker may be a node included in the MCP network.

The node vulnerability tracker may monitor whether an internet protocol (“IP”) address of the final-approver node has changed. Based on the monitoring, the node vulnerability tracker may determine that the IP address of the final-approver node has changed. Based on the determination that the IP address of the final-approver node has changed, the node-vulnerability tracker may transmit a command to the approver segregator to select a new final-approver node from the group of nodes. The new final-approver node may be a node that is different from the previously selected final approver node.

The node vulnerability tracker may monitor whether a level of trust between the final-approver node and other nodes included in the MCP network has diminished. Based on the monitoring, the node vulnerability tracker may determine that the level of trust between the final-approver node and other nodes included in the MCP network has diminished. Based on the determination that the level of trust between the final-approver node and other nodes in the network has diminished, the node vulnerability tracker may transmit a command to the approver segregator to select a new final-approver node from the group of nodes. The new final-approver node may be a node that is different from the previously selected final approver node.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

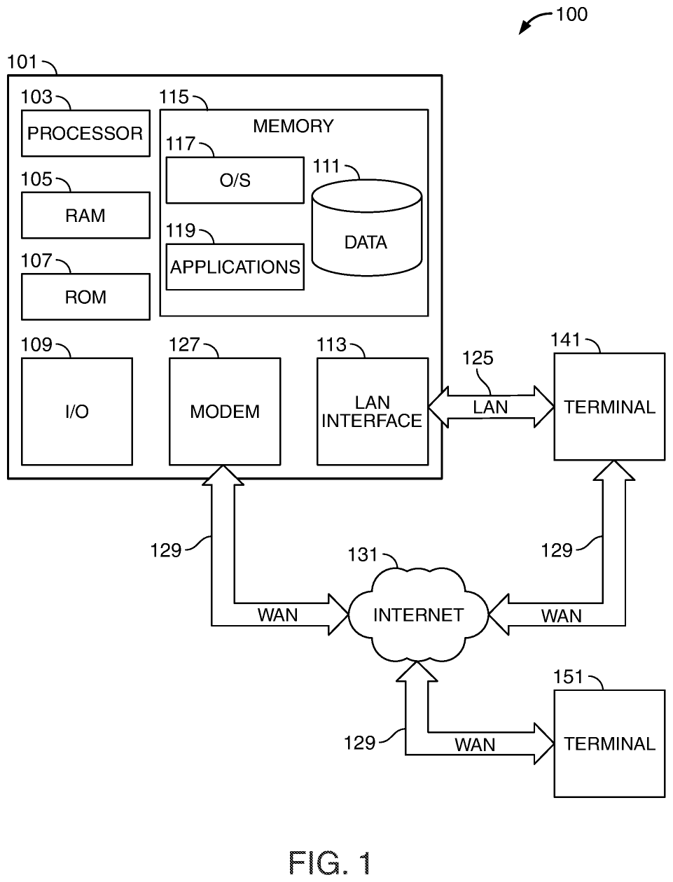

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the nodes, network devices, artificial intelligence (“AI”) models, and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer-e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files. Computing devices, nodes, AI models, databases, network devices and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touchscreen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections within system 100 and terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

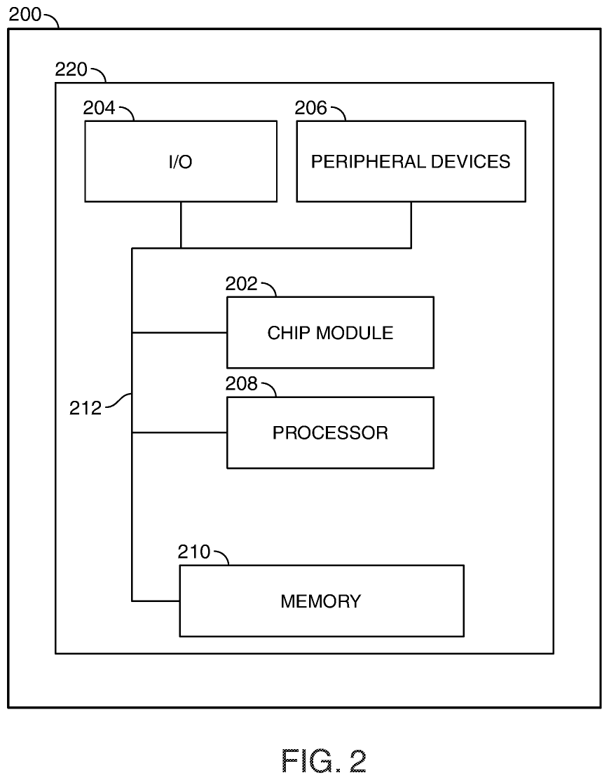

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

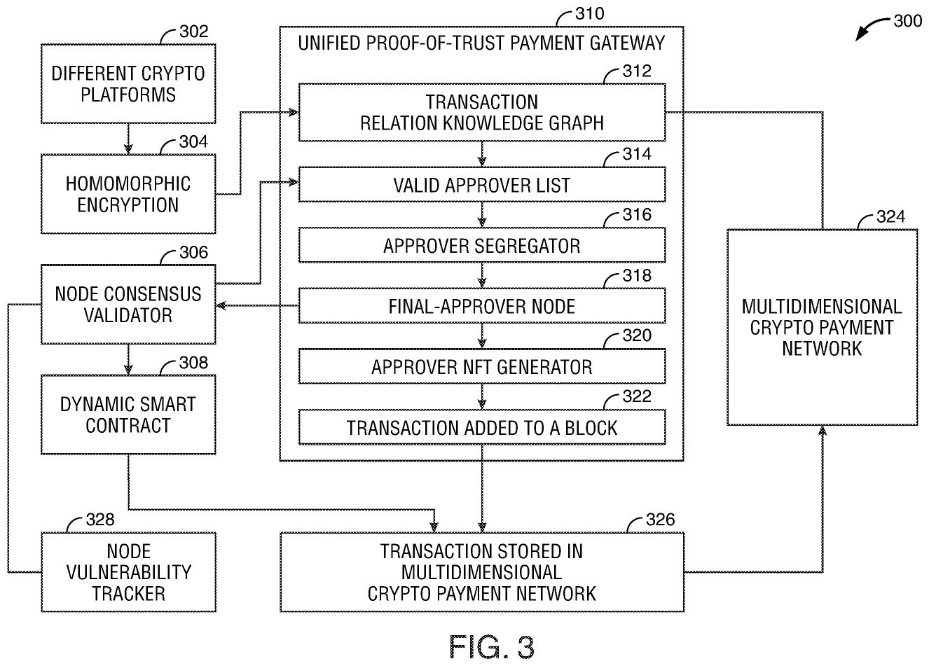

FIG. 3 shows illustrative architecture of crypto payment verification system 300. Crypto payment verification system 300 may receive a pending transaction for authentication and storage. The pending transaction may be initiated between a sender node and a receiver node. The sender node and receiver node may be included in multidimensional crypto payment (“MCP”) network 324. The sender node and receiver node may include one or more features in common with computer 101 and apparatus 200.

The pending transaction may be received from a crypto payment platform included in different crypto platforms 302. Different crypto platforms 302 may include crypto platforms such as multidimensional metaverses, crypto automated teller machines (“ATMs”), bitcoin platforms, crypto lending platforms and/or any other suitable cryptocurrency supported platforms. The pending transaction may be received in a transaction data packet. The transaction data packet may include sender node identification, receiver node identification and transaction related data. After receiving the pending transaction, crypto payment verification system 300 may enable homomorphic encryption 304.

Homomorphic encryption 304 may include homomorphically encrypting data included in the transaction data packet. Homomorphic encryption 304 may include encrypting transaction related data, such as a location of the transaction, an amount of resources agreed to be transferred between the sender node and the receiver node, financial account information relating to the sender node and/or the receiver node and/or any other suitable transaction related data. The sender node identification and the receiver node identification may not be homomorphically encrypted. Following the homomorphic encryption, the transaction data packet may be transmitted to unified proof-of-trust gateway 310.

Unified proof-of-trust gateway 310 may be connected to transaction-relation knowledge graph 312. Transaction-relation knowledge graph 312 may include identification data of one or more nodes included in MCP network 324. The knowledge graph may include transaction data relating to previous transactions executed between the one or more nodes. Valid approver list 314 may be generated using transaction-relation knowledge graph 312. Valid approver list 314 may be generated by identifying which nodes have previously completed transactions with both the sender node and the receiver node. The data regarding the previously completed transactions may be received from the nodes included in MCP network 324.

Approver segregator 316 may select final-approver node 318. The final-approver node may be selected from the nodes that have been identified as having previously completed transactions with both the sender node and the receiver node. Approver segregator 316 may select final-approver node 318 based on a set of predetermined criteria. Approver segregator 316 may select final-approver node 318 based on which node is the most similar based on a threshold level similarity to the predetermined criteria.

After selecting final-approver node 318, non-fungible token (“NFT”) 320 may be generated. After NFT 320 is generated, the pending transaction and NFT 320 may be added to block 322. Once final-approver node 318 and NFT 320 are validated, the transaction may be enabled and block 322 may be added to MCP network 324. In parallel to generating NFT 320, node consensus validator 306 may validate final-approver node 318. Node consensus validator 306 may be included in MCP network 324. Node consensus validator 306 may be configured to validate final-approver node 318. Node consensus validator 306 may create dynamic smart contract 308. Dynamic smart contract 308 may be a smart contract used to verify final-approver node 318. Following the verification of final-approver node 318, dynamic smart contract 308 may be executed to enable the pending transaction. Dynamic smart contract 308 may include NFT 320, sender node identification information, receiver node identification information, final-approver node identification information and/or a set of predetermined parameters configured to enable execution of dynamic smart contract 308.

Crypto payment verification system 300 may include node vulnerability tracker 328. Node vulnerability tracker 328 may be included in the MCP network 324. Node vulnerability tracker 328 may be configured to identify changes in security status of final-approver node 318. In response to a detection of a change in the security status of final-approver node 318, node consensus validator 306 may fail to validate dynamic smart contract 308. In response to failing to validate dynamic smart contract 308, node consensus validator 306 may select a new final-approver node from valid approver list.

In response to validating dynamic smart contract 308, the pending transaction may be stored as transaction 326 in MCP network 324. In response to storing the pending transaction as transaction 326, the pending transaction may be enabled. Upon enabling transaction 326 resources may be transferrable between the sender node and the receiver node as specified in transaction related data.

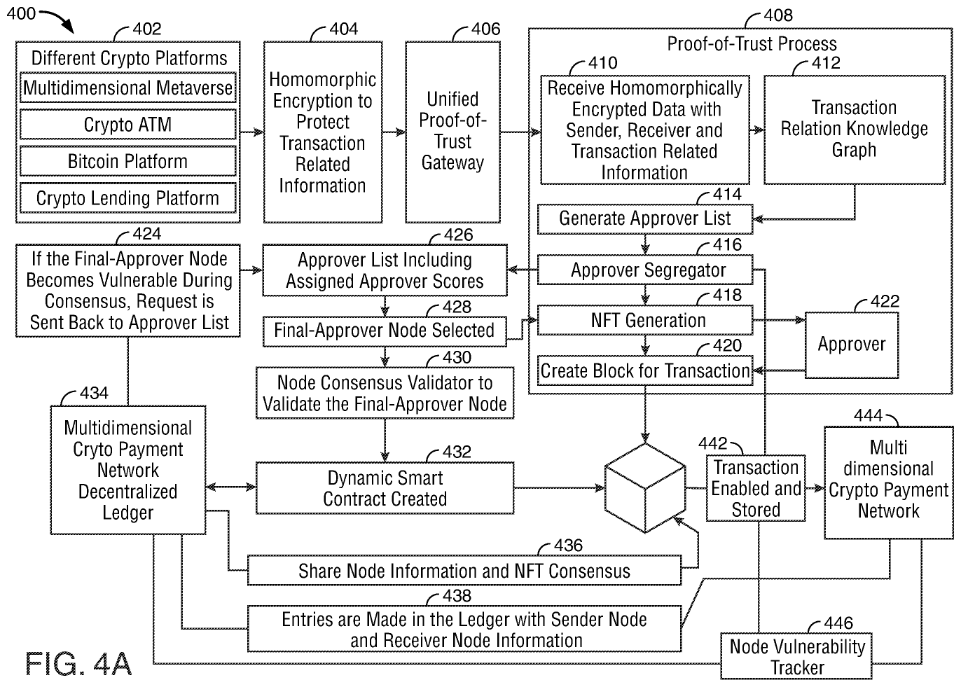

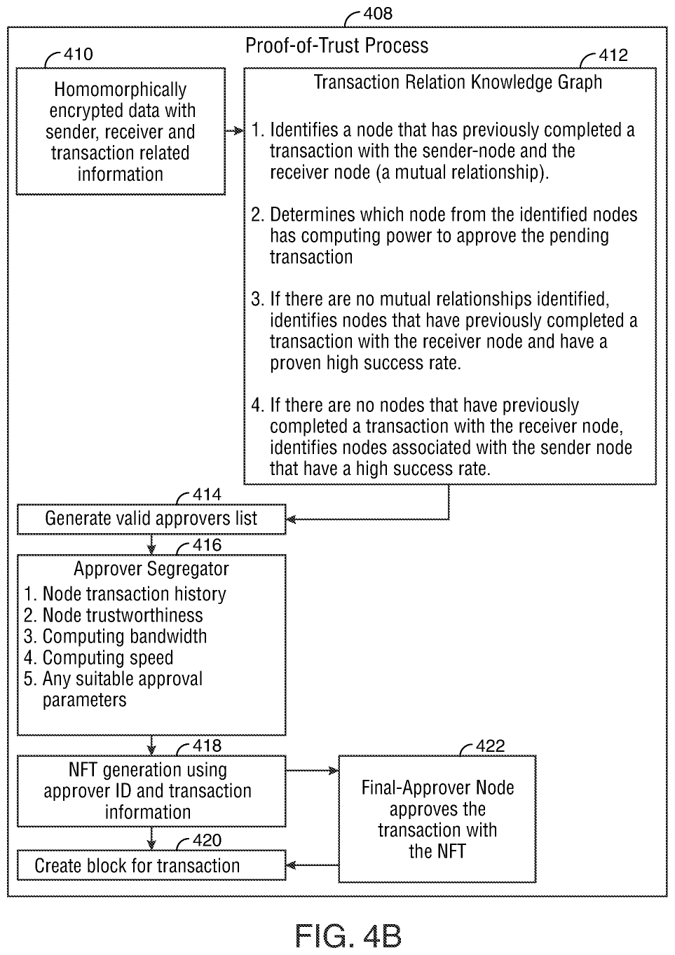

FIG. 4A-4B show illustrative crypto payment verification process 400. Crypto payment verification process 400 may include one or more features in common with crypto payment verification system 300. At step 402, a crypto transaction may be initiated via a crypto platform. The crypto transaction may be initiated between a sender node and a receiver node. The sender node and receiver node may be included in a network. The network may include a blockchain. In response to initiating a crypto transaction, a transaction data packet may be created. The transaction data packet may include sender node identification, receiver node identification and transaction related information.

Step 404 may include homomorphically encrypting the transaction data packet. Step 404 may include homomorphically encrypting the transaction related information and not homomorphically encrypting the sender node identification and receiver node identification. After the homomorphic encryption, at step 406, the transaction data packet may be transmitted to unified proof-of-trust gateway. At step 408, the transaction data packet may be processed, through the proof-of-trust process.

The proof-of-trust process may include receiving the homomorphically encrypted transaction data packet, at step 410. At step 412, the proof-of-trust process may include extracting the sender node identification and the receiver node identification from the transaction data packet. Step 412 may include transmitting the sender node identification and receiver node identification to a transaction-relation knowledge graph. The transaction-relation knowledge graph may include identification data of one or more nodes included in the network. The transaction-relation knowledge graph may include transaction data relating to previous transactions between the one or more nodes.

At step 412, transaction-relation knowledge graph may identify a group of nodes. Each node in the group of nodes may have previously executed a transaction with the sender node with the receiver node. The transaction-relation knowledge graph may determine which nodes from the identified group of nodes has enough computing power to approve the pending transaction. In the event that there are no nodes identified that have previously completed transactions with both the sender node and receiver node, the transaction-relation knowledge graph may identify a second group of nodes. Each node in the second group of nodes may have previously completed a transaction with the receiver node at a greater than a predetermined success rate. In the event that the transaction-relation knowledge graph does not identify nodes that have previously completed a transaction with the receiver node, the transaction-relation knowledge graph may identify a third group of nodes. Each node included in the third group of nodes may have previously completed a transaction with only the sender node at a greater than a predetermined success rate.

At step 414, an approver list may be generated using the group of nodes identified by transaction-relation knowledge graph at step 412. At step 416, an approver segregator may assign an approver score to each of the nodes included in the approver list. The approver score may be assigned based on node transaction history, node trustworthiness, computing bandwidth, computing speed and any other suitable approval parameters. At step 426, the approver list may be updated with the assigned approval scores. At step 428, a final-approver node may be selected. The final approver-node may be selected based on the assigned approver score.

After the final-approver node is selected, the final-approval node may generate an NFT, at step 418. At step 422, the final-approver node may approve, with the NFT, the pending transaction. At step 420, a block may be created for the approved transaction. In parallel with step 418, prior to step 422, a node consensus validator may validate the final-approver node at step 430. To validate the final-approver node may create a dynamic smart contract at step 432. The dynamic smart contract may include the NFT, sender node identification information, receiver node identification information, final-approver node identification information and a set of predetermined parameters. At step 434, the dynamic smart contract may be enabled through a MCP network decentralized ledger. Once the dynamic smart contract is enabled, the node information included in the smart contract, and the NFT token consensus may be transmitted to the block for storage in step 436. In response to enabling of the dynamic smart contract, steps 422 and 420 may be executed. At step 442, the pending transaction may be enabled and stored. The transaction may be stored at MCP network 444. At step 438, MCP network decentralized ledger may be dynamically updated with changes in MCP network 444.

Node vulnerability tracker 446 may track the status of nodes included in MCP network 444, during crypto payment verification process 400. For example, node vulnerability tracker 446 may identify vulnerability of the final-approver node. In response to identifying vulnerability of the final-approver node, step 424 may include identifying a new final-node approver from the approver list.

Thus, methods and apparatus for PROOF-OF-TRUST BASED MULTIDIMENSIONAL CRYPTO-PLATFORM PAYMENT GATEWAY are provided. Persons skilled in the art will appreciate that the present disclosure can be practiced by other than the described embodiments, which are presented for purposes of illustration rather than of limitation and that the present disclosure is limited only by the claims that follow.

1. A method for resource efficient and decentralized verification, approval and storage of pending crypto transactions, the method leveraging smart contracts, non-fungible tokens and knowledge graphs, the method including:
receiving at a unified payment gateway a transaction data packet from a crypto payment platform, the unified payment gateway being part of a multidimensional crypto payment (“MCP”) network, the MCP network being a decentralized network having one or more nodes, wherein the transaction data packet includes:
a pending crypto transaction between a sender node and a receiver node;
sender node identification; and
receiver node identification;
transmitting, from the unified payment gateway, the transaction data packet to a knowledge graph including:
identification data of the one or more nodes; and
transaction data relating to previous transactions between the one or more nodes;
identifying, in the knowledge graph, a group of nodes from the one or more nodes, each of the group of nodes having previously completed at least one transaction with the sender node and at least one transaction with the receiver node;
assigning an approver score to each node included in the group of nodes by determining, for each node:
previous transaction history with the receiver node;
previous transaction history with the sender node; and
trustworthiness based on previous transaction history;
selecting a final-approver node from the group of nodes, the final-approver node being a node having a highest assigned approval score;
using the final-approver node to generate a non-fungible token (“NFT”) for approving the pending crypto transaction;
in parallel with the generating of the NFT, transmitting final-approver node identification to a node consensus validator, the node consensus validator configured to validate the final-approver node;
creating, using the node consensus validator, a smart contract, the smart contract including the sender node identification, the receiver node identification, the final-approver node identification, the NFT, and a set of rules to validate the smart contract;
validating the smart contract using one of the one or more nodes in the MCP network, the validating including solving the set of rules; in response to validating the smart contract;
approving the pending crypto transaction; and
storing the crypto transaction in the MCP network; and
exchanging crypto payment-related resources between the receiver node and the sender node as specified by the crypto transaction.

2. The method of claim 1 further including homomorphically encrypting the transaction data packet prior to receiving the transaction data packet.

3. The method of claim 2 further including homomorphically encrypting data relating to the pending crypto transaction and not homomorphically encrypting data relating to sender node identification and receiver node identification.

4. The method of claim 1 further including:
tracking the final-approver node using a node vulnerability tracker, wherein the tracking includes monitoring if an internet protocol (“IP”) address of the final-approver node has changed;
based on the monitoring determining that the IP address of the final-approver node has changed;
based on the determining, transmitting a command to the knowledge graph to select a new final-approver node from the group of nodes, wherein the new final-approver node is different from the final approver node.

5. The method of claim 1 further including:
tracking the final-approver node using a node vulnerability tracker, wherein the tracking includes monitoring if a level of trust between the final-approver node and other nodes included in the MCP network is diminished;
based on the monitoring determining that the level of trust between the final-approver node and other nodes is diminished; and
based on the determining, transmitting a command to the knowledge graph to select a new final-approver node from the group of nodes, wherein the new final-approver node is different from the final approver node.

6. The method of claim 1 further comprising dynamically updating the knowledge graph in response to a node being added to the MCP network, the updating comprising updating the knowledge graph with:
identification data of the node being added; and
transaction data relating to previous and ongoing transactions between the node being added and the one or more nodes included in the MCP network.

7. The method of claim 6 wherein the updating is executed in real-time.

8. A unified payment gateway for resource efficient and decentralized verification, approval and storage of pending crypto transactions, the unified payment gateway leveraging smart contracts, non-fungible tokens and knowledge graphs, the unified payment gateway being included in a multidimensional crypto payment (“MCP”) network, the MCP network being a decentralized network having one or more nodes, the unified payment gateway comprising:
a node, the node comprising:
a receiver configured to receive a transaction data packet from a crypto payment platform, the transaction data packet including:
a pending crypto transaction between a sender node and a receiver node, the sender and receiver node included in the MCP network;
sender node identification; and
receiver node identification;
a transmitter configured to transmit the transaction data packet from the unified payment gateway to a knowledge graph, the knowledge graph comprising:
identification data of the one or more nodes; and
transaction data relating to previous transactions between the one or more nodes;
an approver segregator configured to:
identify, in the knowledge graph, a group of nodes from the one or more nodes, each of the group of nodes having previously completed at least one transaction with the sender node and at least one transaction with the receiver node;
assign an approver score to each node included in the group of nodes by determining, for each node:
previous transaction history with the receiver node;
previous transaction history with the sender node; and
trustworthiness based on previous transaction history;
select a final-approver node from the group of nodes, the final-approver node being a node having a highest assigned approval score;
a non-fungible token (“NFT”) generator configured to use the final-approver node to generate an NFT to use for approval of the pending crypto transaction; and
a node consensus validator configured to validate the final-approver node, the node consensus validator configured to:
create a smart contract, the smart contract including the sender node identification, the receiver node identification, final-approver node identification, the NFT, and a set of rules to validate the smart contract; and
validate the smart contract, the validation including solving the set of rules; and
in response to validating the smart contract, the unified payment gateway is configured to:
approve the pending crypto transaction; and
store the crypto transaction in the MCP network;
wherein in response to storing the crypto transaction, the unified payment gateway is configured to enable an exchange of crypto payment-related resources between the receiver node and the sender node as specified by the crypto transaction.

9. The unified payment gateway of claim 8 wherein the transaction data packet is configured to be homomorphically encrypted prior to transmission of the transaction data packet.

10. The unified payment gateway of claim 9 wherein data relating to the pending crypto transaction is configured to be homomorphically encrypted and data relating to sender node identification and receiver node identification is not configured to be homomorphically encrypted.

11. The unified payment gateway of claim 8 further comprises a node vulnerability tracker, the node vulnerability tracker configured to:
monitor if an internet protocol (“IP”) address of the final-approver node has changed;
based on the monitoring, determine that the IP address of the final-approver node has changed; and
based on the determining, transmit a command to the approver segregator to select a new final-approver node from the group of nodes, wherein the new final-approver node is different from the final approver node.

12. The unified payment gateway of claim 8 further comprises a node vulnerability tracker, the node vulnerability tracker configured to:
monitor if a level of trust between the final-approver node and other nodes included in the MCP network is diminished; and
based on the monitoring, determine that the level of trust between the final-approver node and other nodes included in the MCP network has diminished; and
based on the determining, transmit a command to the approver segregator to select a new final-approver node from the group of nodes, wherein the new final-approver node is different from the final approver node.

13. The unified payment gateway of claim 8 further configured to dynamically update the knowledge graph in response to a node being added to the MCP network, the unified payment gateway is configured to update the knowledge graph with:
identification data of the node being added; and
transaction data relating to previous and ongoing transactions between the node being added and the one or more nodes included in the MCP network.

14. The unified payment gateway of claim 13 wherein the update is configured to be executed in real-time.

15. A method for resource efficient and decentralized verification, approval and storage of pending crypto transactions, the method leveraging smart contracts, non-fungible tokens and knowledge graphs, the method including:
receiving at a unified payment gateway a transaction data packet from a crypto payment platform, the unified payment gateway being part of a first network, the first network being a decentralized network having first network nodes, wherein the transaction data packet includes:
a pending crypto transaction between a sender node and a receiver node;
sender node identification; and
receiver node identification;
transmitting, from the unified payment gateway, the transaction data packet to a knowledge graph including:
identification data of the first network nodes;
identification data of second network nodes, the second network nodes included in a second network, the second network different from the first network; and
transaction data relating to previous transactions between the first and second network nodes;
identifying, in the knowledge graph, a group of nodes from first network nodes and second network nodes, each node included in the group of nodes having previously completed at least one transaction with the sender node and at least one transaction with the receiver node;
assigning an approver score to each node included in the group of nodes by determining, for each node:
previous relationship history with the receiver node;
previous relationship history with the sender node; and
trustworthiness based on previous transaction history;
selecting a final-approver node from the group of nodes, the final-approver node being a node having a highest assigned approval score;
using the final-approver node to generate a non-fungible token (“NFT”) for approving the pending crypto transaction;
in parallel with the generating of the NFT, transmitting final-approver node identification to a node consensus validator, the node consensus validator configured to validate the final-approver node;
creating, using the node consensus validator, a smart contract, the smart contract including the sender node identification, the receiver node identification, the final-approver node identification, the NFT, and a set of rules to validate the smart contract;
validating the smart contract using a node selected from the first network nodes and the second network nodes, the validating including solving the set of rules;
in response to validating the smart contract;
approving the crypto transaction; and
storing the crypto transaction in the first network; and
exchanging crypto payment-related resources between the receiver node and the sender node as specified by the crypto transaction.

16. The method of claim 15 wherein the final-approver node is selected from the first network nodes.

17. The method of claim 15 wherein the final-approver node is selected from the second network nodes.

18. The method of claim 15 wherein the node selected for validating the smart contract is selected from the first network nodes.

19. The method of claim 15 wherein the node selected for validating the smart contract is selected from the second network nodes.

20. The method of claim 15 further comprising dynamically updating the knowledge graph in response to a node being added to either the first network or the second network, the updating comprising updating the knowledge graph with:
identification data of the node being added; and
transaction data relating to previous and ongoing transactions between the node being added and first and second network nodes.
